(19) United States
(12) Patent Application Publication
(10) Pub. No.: US 2021/0017344 A1
(43) Pub. Date: Jan. 21, 2021

(54) LASER TRANSPARENT COMPOSITIONS AND METHODS OF LASER WELDING

(71) Applicant: LYONDELLBASELL ADVANCED POLYMERS INC., HOUSTON, TX (US)

(72) Inventors: YING SHI, AKRON, OH (US); DENNIS C. SMITH, AKRON, OH (US)

(73) Assignee: LYONDELLBASELL ADVANCED POLYMERS INC., HOUSTON, TX (US)

(21) Appl. No.: 16/932,424

(22) Filed: Jul. 17, 2020

Related U.S. Application Data
(60) Provisional application No. 62/876,088, filed on Jul. 19, 2019.

(51) Int. Cl. C08J 5/12; C08L 23/12; B29C 65/14

(52) U.S. Cl. CPC C08J 5/121; C08L 23/12; B29C 65/1438; B29C 65/148; C08L 2201/10; C08J 2423/30; C08L 2205/08; C08L 2205/025; C08L 2201/08; C08J 2323/12

(57) ABSTRACT

Laser transparent compositions that may be black in color. The laser transparent compositions may include a matrix material that includes a polypropylene, a dye system that includes one, and optionally two or more, polar organic compounds, a plurality of glass fibers, and a UV stabilizer. Methods of laser welding, which may include irradiating a laser absorbing composition that contacts a laser transparent composition at an interface.

### CROSS-REFERENCE TO RELATED APPLICATIONS

This application is the Non-Provisional Patent Application, which claims benefit of priority to U.S. Provisional Application No. 62/876,088, filed Jul. 19, 2019, the contents of which are incorporated herein by reference in their entirety.

### BACKGROUND

Laser welding is a technique that may be used to weld two materials together. A first material may be laser transparent, at least to a certain degree, and a second material is laser absorbing. The laser absorbing material, therefore, may be heated (and subsequently liquefied) by laser irradiation that is directed at and through the first material. Examples of laser welding are disclosed at U.S. Patent Application Publication No. 2003/0039837 and U.S. Patent Application Publication No. 2005/0203225, which are incorporated herein by reference.

Carbon black is a common colorant in plastics, but carbon black readily absorbs laser energy. Therefore, it is difficult, if not impossible, to subject two plastic materials that include carbon black to laser welding, because the presence of carbon black in both materials prevents or interferes with the ability to irradiate and heat the materials at their interface.

Most polypropylene resins are laser transparent, but polypropylene resins may not be black in color. Therefore, the laser welding of such a polypropylene resin to a carbon black-containing material results in a single material having regions of different color.

There remains a need for laser-transparent polypropylene-based materials, including those that are glass fiber reinforced and/or UV stabilized, which are black in color.

### BRIEF SUMMARY

Provided herein are laser transparent compositions that are black in color, and may be laser welded to a laser absorbing composition. The laser transparent compositions may include a dye system that (i) includes two or more polar organic compounds, and (ii) can surprisingly impart a non-polar polypropylene matrix material with a black color that is similar, if not identical, to the color of laser absorbing compositions that include carbon black as a colorant. The dye system also may be added to the laser transparent compositions provided herein without undesirably impacting the laser transparency of the laser transparent compositions. The laser transparent compositions provided herein may have a laser transparency of at least 50%, and, in some embodiments, are transparent to laser irradiation that includes a wide range of one or more wavelengths (e.g., 740 nm or greater).

In one aspect, laser transparent compositions are provided, including laser transparent compositions that are black in color. In some embodiments, the laser transparent compositions include a matrix material that includes a polypropylene; a dye system that includes two or more polar organic compounds; a compatibilizer; a plurality of glass fibers; and a UV stabilizer; wherein the laser transparent composition has a laser transparency of at least 50%.

In some embodiments, the laser transparent compositions include a matrix material that includes a polypropylene; a dye system that includes two or more polar organic compounds, wherein the dye system is (i) dispersed in the matrix material, and (ii) present at an amount effective to impart a black color to the laser transparent composition; a compatibilizer, wherein the compatibilizer is (i) dispersed in the matrix material, and (ii) present at an amount of about 0.1% to about 10%, by weight, based on the weight of the laser transparent composition; a plurality of glass fibers, wherein the plurality of glass fibers is (i) dispersed in the matrix material, and (ii) present at an amount of about 1% to about 40%, by weight, based on the weight of the laser transparent composition; and a UV stabilizer, wherein the UV stabilizer is (i) dispersed in the matrix material, and (ii) present at an amount of about 0.1% to about 2%, by weight, based on the weight of the laser transparent composition; wherein the laser transparent composition has a laser transparency of at least 50%.

In another aspect, methods of laser welding are provided. In some embodiments, the methods of laser welding include providing (i) a laser transparent composition as described herein, and (ii) a laser absorbing composition that is black in color, wherein the laser transparent composition and the laser absorbing composition contact each other at an interface; and directing laser irradiation through the laser transparent composition to heat at least a portion of the laser absorbing composition at the interface for a time effective to liquefy at least part of (i) the portion of the laser absorbing composition at the interface, (ii) a portion of the laser transparent composition at the interface, or (iii) a combination thereof. In some embodiments, the methods of laser welding also include solidifying (i) the portion of the laser absorbing composition at the interface, (ii) the portion of the laser transparent composition at the interface, or (iii) a combination thereof to weld the laser transparent composition and the laser absorbing composition together at least at the interface.

Additional aspects will be set forth in part in the description which follows, and in part will be obvious from the description, or may be learned by practice of the aspects described herein. The advantages described herein may be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

FIG. 1A depicts an embodiment of a laser transparent composition and an embodiment of a laser absorbing composition that contact each other at an interface prior to laser welding.

FIG. 1B depicts an embodiment of a laser transparent composition through which laser radiation is directed to heat and subsequently liquefy an embodiment of a laser absorbing composition at an interface.

FIG. 1C depicts an embodiment of a laser transparent composition that includes a portion that has been heated and subsequently liquefied via heat conduction from a portion of a laser absorbing composition.

FIG. 1D depicts an embodiment of a laser transparent composition that has been laser welded to an embodiment of a laser absorbing composition.

### DETAILED DESCRIPTION

The laser transparent compositions provided herein may have a laser transparency of at least 50%. A composition has a laser transparency of at least 50% when at least 50% of laser radiation of one or more particular wavelengths directed at the composition is transmitted through, and not absorbed by, the composition. In some embodiments, the laser transparent compositions provided herein have a laser transparency of at least 50% for laser radiation of one or more wavelengths of 740 nm or greater. In some embodiments, the laser transparent compositions provided herein have a laser transparency of at least 65%. In some embodiments, the laser transparent compositions provided herein have a laser transparency of at least 65% for laser radiation of one or more wavelengths of 740 nm or greater.

Matrix Materials

The laser transparent compositions provided herein may include a matrix material that includes a polypropylene. As used herein, the phrase “matrix material” refers to a material in which one or more components (e.g., glass fibers, compatibilizer, etc.) of a composition are dispersed. A polypropylene of a matrix material may include one or more types of polypropylene, such as a polypropylene homopolymer, a polypropylene co-polymer, etc. In some embodiments, the matrix materials of the laser transparent compositions described herein include at least 95%, by weight, or at least 99%, by weight, of polypropylene (e.g., polypropylene homopolymer, polypropylene co-polymer, or a combination thereof), based on the weight of the matrix material.

In some embodiments, a polypropylene of a matrix material includes EXXONMOBIL® PP1105E1 polypropylene, EXXONMOBIL® ACHIEVE® Advanced PP1605 polypropylene, or a combination thereof. In some embodiments, the polypropylene of a matrix material may be a homopolymer polypropylene and may have a melt mass-flow rate of from 25-50 g/10 min. (ASTMD1238, 230° C./2.16 kg), alternatively from 30-45 g/10 min. and alternatively 35 g/10 min; and a density of from 0.85 to 0.95 g/cm³ and alternatively 0.900 g/cm³, a tensile strength at yield (51 mm/min) of from 30 to 50 MPa (based on D638), and alternatively from 34 to 40 MPa and alternatively 34.6 MPa. In some embodiments, the polypropylene of a matrix material may be a homopolymer polypropylene and may have a melt mass-flow rate of from 25-50 g/10 min. (ASTMD1238, 230° C./2.16 kg), alternatively from 30-45 g/10 min. and alternatively 32 g/10 min; and a density of from 0.85 to 0.95 g/cm³ and alternatively 0.900 g/cm³, a tensile strength at yield (51 mm/min) of from 30 to 50 MPa (based on D638), and alternatively from 32 to 40 MPa and alternatively 33.3 MPa.

Dye Systems

The laser transparent compositions provided herein may include a dye system. The dye system may be configured to impart a laser transparent composition with a desired color. The desired color, in some embodiments, is black. The dye systems may include two or more polar organic compounds.

The term “black”, the phrases “black color” or “black in color”, or the like, as used herein, refer to pure black and the various shades of black (i.e., off-black colors). Non-limiting examples of shades of black that are encompassed by the term “black”, the phrases “black color” or “black in color”, or the like, as used herein, include the following shades, which are referred to by their common names and are provided with their CMYK coordinates: licorice (0, 35, 39, 90); eerie black (0, 0, 0, 89); Charleston green (18, 0, 0, 83); raisin black (0, 8, 0, 86); black leather jacket (30, 0, 23, 79); jet (0, 0, 0, 80); onyx (7, 0, 2, 78); black olive (2, 9, 10, 77); black bean (0, 80, 97, 6); café noir (0, 28, 56, 71); outer space (15, 0, 3, 70); charcoal (32, 13, 0, 69); Davy's gray (0, 0, 0, 67); taupe (0, 60, 60, 30); ebony (9, 0, 14, 64); dim gray (0, 0, 0, 59); midnight blue (97, 78, 39, 29); and the like.

The two or more polar organic compounds may have different colors. For example, the combination of red dye and green dye; the combination of blue dye, red dye, and yellow dye; the combination of green dye, red dye, and yellow dye; the combination of blue dye, green dye, red dye, and yellow dye; and the combination of green dye, violet dye, and yellow dye can be used. The ratio of dyes in the dye systems provided herein may be adjusted based on one or more factors, such as the color tone of the dye, the matrix material used, the concentration of a dye system in a laser transparent composition, the concentration of the dyes in a dye system, etc. Dye chemistry types which can be used are to obtain black coloration via combination are quinophthalone dyes, anthraquinone dyes, perinone dyes, and monoazo complex dyes.

Examples of useful quinophthalone type dyes are Yellow Dye: C.I. Solvent Yellow 33 and 157.

Examples of useful anthraquinone dyes are Green dye: C.I. Solvent Green 3, 20, 22, 23, 26, 28, 29; Blue dye: C.I. Solvent Blue 11, 13, 14, 35, 36, 59, 63, 69, 94, 132; C.I. Vat Blue 4, 6, 14; Violet dye: C.I. Solvent Violet 12, 13, 14, 31, 34; Red dye: C.I. Solvent Red 52, 111, 114, 152, 155; Yellow dye: C.I. Solvent Yellow 163; C.I. Vat Yellow 1, 2, 3.

Examples of useful perinone dyes are Violet dye: C.I. Solvent Violet 29; Red dye: C.I. Solvent Red 135, 162, 178, 179; C.I. Vat Red 7; Orange dye: C.I. Solvent Orange 60, 78; and C.I. Vat Orange 15.

Examples of useful monoazo complex dyes are Black dye: C.I. Solvent Black 21, 22, 23, 27, 28, 29, 31; C.I. Acid Black 52, 60, 99; Blue dye: C.I. Acid Blue 167; Violet dye: C.I. Solvent Violet 21; Red dye: C.I. Solvent Red 8, 83, 84, 121, 132; C.I. Acid Red 215, 296; Orange dye: C.I. Solvent Orange 37, 40, 44, 45; C.I. Acid Orange 76; Yellow dye: C.I. Solvent Yellow 21, 61, 81; C.I. Acid Yellow 59, 151.

Examples of useful perylene dyes which can be used exclusively or in combination to achieve black coloration are NIR transparent black pigments of perylene type, BASF Lumogen® Black K8007 and Lumogen® Black K0088, which may be black in color and from 50-90% laser transparent at from 808 to 1064 nanometers with a 7.5% pigment loading applied to a PET film of 500 microns.

In some embodiments, the dye system is dispersed in a matrix material, and present at an amount effective to impart a desired color, such as black, to a laser transparent composition. In some embodiments, the dye system is evenly dispersed in a matrix material. In some embodiments, the dye system dispersed in the laser transparent composition imparts a color to the laser transparent composition that matches the color (based on a casual observer's naked eye) of a base composition to which it is to be welded.

In some embodiments, the two or more polar organic compounds of a dye system include a red dye and a green dye. The red dye and the green dye may be present at any ratio effective to impart a laser transparent composition with a desired color, such as black. In some embodiments, the red dye and the green dye are present in the dye system at a weight ratio of about 40:60 (red dye:green dye) to about 60:40 (red dye:green dye). In some embodiments, the red dye and the green dye are present in the dye system at a weight ratio of about 45:55 (red dye:green dye) to about 55:45 (red dye:green dye). In some embodiments, the red dye and the green dye are present in the dye system at a weight ratio of about 50:50 (red dye:green dye). In some embodiments, the red dye includes MACROLEX® Red EG dye (LANXESS, USA). In some embodiments, the green dye includes MACROLEX® Green 5B (LANXESS, USA). In some embodiments, the red dye includes MACROLEX® Red EG dye (LANXESS, USA), and the green dye includes MACROLEX® Green 5B (LANXESS, USA). In some embodiments, the red dye has a color index part I of solvent red 135 and a part II of 564120. In some embodiments, the red dye may be chemically described as perinone dyestuff. In some embodiments, the red dye may have any of the following properties: an approximate density of 1.74 g/cm³ at 23° C.; shade of red with a yellow cast; a ⅓ standard depth of 0.40% dyestuff (determined in GP-PS with 2% TiO₂); a bulk density of 0.44 g/cm3 (according to DIN ISO 787-11); a melting point of 318° C., and combinations thereof. In some embodiments, the green dye has a color index part I of solvent green 3 and a part II of 61565. In some embodiments, the red dye may be chemically described as anthraquinone dyestuff. In some embodiments, the red dye may have any of the following properties: an approximate density of 1.35 g/cm³ at 23° C.; shade of green with a blue cast; a ⅓ standard depth of 0.20% dyestuff (determined in GP-PS with 2% TiO₂); a bulk density of 0.18 g/cm3 (according to DIN ISO 787-11); a melting point of 213° C., and combinations thereof.

In some embodiments, the dye system is present at an amount of about 0.05% to about 0.5%, by weight, based on the weight of a laser transparent composition. In some embodiments, the dye system is present at an amount of about 0.1% to about 0.5%, by weight, based on the weight of a laser transparent composition. In some embodiments, the dye system is present at an amount of about 0.1% to about 0.4%, by weight, based on the weight of a laser transparent composition. In some embodiments, the dye system is present at an amount of about 0.1% to about 0.3%, by weight, based on the weight of a laser transparent composition. In some embodiments, the dye system is present at an amount of about 0.2%, by weight, based on the weight of a laser transparent composition.

Compatibilizers

The laser transparent compositions provided herein may include a compatibilizer. As used herein, the term “compatibilizer” refers to any one or more materials that can improve the stability of compositions that include two components that differ, due, for example, to their polar and non-polar characters. For example, in the laser transparent compositions provided herein, the matrix material that includes a polypropylene is non-polar, but the dye system that includes at least two polar organic compounds is polar.

In some embodiments, a compatibilizer is dispersed in a matrix material that includes a polypropylene. The compatibilizer may be evenly dispersed in a matrix material.

In some embodiments, a compatibilizer is present in the laser transparent compositions provided herein at an amount of about 0.1% to about 10%, by weight, based on the weight of the laser transparent compositions. In some embodiments, a compatibilizer is present in the laser transparent compositions provided herein at an amount of about 0.1% to about 8%, by weight, based on the weight of the laser transparent compositions. In some embodiments, a compatibilizer is present in the laser transparent compositions provided herein at an amount of about 0.1% to about 6%, by weight, based on the weight of the laser transparent compositions. In some embodiments, a compatibilizer is present in the laser transparent compositions provided herein at an amount of about 0.1% to about 4%, by weight, based on the weight of the laser transparent compositions. In some embodiments, a compatibilizer is present in the laser transparent compositions provided herein at an amount of about 1% to about 3%, by weight, based on the weight of the laser transparent compositions.

In some embodiments, the compatibilizers include a modified polypropylene homopolymer. The modified polypropylene homopolymer may include (i) a polypropylene homopolymer, and (ii) a monomer that includes a polar functional group, wherein the monomer that includes the polar functional group is grafted (e.g., covalently bonded) to the polypropylene homopolymer. The monomer that includes a polar functional group may include any moiety, such as a double bond or triple bond, that is capable of reacting with the polypropylene homopolymer to graft the monomer that includes a polar functional group to the polypropylene homopolymer.

Any amount of monomer that includes the polar functional group may be grafted to the polypropylene homopolymer that is effective to achieve a desired degree of compatibilization. In some embodiments, the monomer that includes the polar functional group is present at an amount of about 1 mole % to about 10 mole % relative to the moles of polypropylene monomer in a polypropylene homopolymer. In some embodiments, the monomer that includes the polar functional group is present at an amount of about 2 mole % to about 10 mole % relative to the moles of polypropylene monomer in a polypropylene homopolymer. In some embodiments, the monomer that includes the polar functional group is present at an amount of about 3 mole % to about 10 mole % relative to the moles of polypropylene monomer in a polypropylene homopolymer. In some embodiments, the monomer that includes the polar functional group is present at an amount of about 3 mole % to about 8 mole % relative to the moles of polypropylene monomer in a polypropylene homopolymer. In some embodiments, the monomer that includes the polar functional group is present at an amount of about 5 mole % to about 7 mole % relative to the moles of polypropylene monomer in a polypropylene homopolymer.

The monomer that includes a polar functional group may include any polar group that is capable of achieving a desired level of compatibilization. In some embodiments, the polar functional group includes a carboxylic acid. In some embodiments, the monomer that includes a polar functional group includes acrylic acid, maleic anhydride, or a combination thereof.

In some embodiments, the compatibilizer has (i) a density of about 0.8 g/cm³ to about 1 g/cm³, (ii) a melt flow rate of about 30 g/10 minutes to about 50 g/10 minutes (2.16 kg at 230° C.), or (iii) a combination thereof. In some embodiments, the compatibilizer has (i) a density of about 0.91 g/cm³, (ii) a melt flow rate of about 42 g/10 minutes (2.16 kg at 230° C.), or (iii) a combination thereof. Melt mass flow rates (MFR) are given in gram/10 min (g/10 min) and were measured using ASTM D 1238, which is entitled “Test Method for Melt Flow Rates of Thermoplastics by Extrusion Plastometer,” under the conditions specified herein. The term “ASTM D 1238” as used herein refers to a standard test method for determining melt flow rates of thermoplastics carried out by an extrusion plastometer. In general, this test method covers the determination of the rate of extrusion of molten thermoplastic resins using an extrusion plastometer. After a specified preheating time, resin is extruded through a die with a specified length and orifice diameter under prescribed conditions of temperature, load, and piston position in the barrel. This test method was approved on August 1, 2013 and published in August 2013, the contents of which are incorporated herein by reference in its entirety. For the referenced ASTM standards, visit the ASTM website, www.astm.org, or contact ASTM Customer Service at service@astm.org. Density is giving in g/cm³ and measured using ISO 1183-1, which is entitled “Plastics-Methods for Determining the Density of Non-Cellular Plastics—Part 1: Immersion method, liquid pycnometer method and titration method.” The term “ISO 1183-1” as used herein refers to the test method published as the second edition dated May 15, 2012, the content of which are incorporated herein by reference in its entirety.

Glass Fibers

The laser transparent compositions provided herein may include a plurality of glass fibers. The plurality of glass fibers may include at least two glass fibers selected to impart one of more characteristics to the laser transparent compositions, including, but not limited to, one or more improved mechanical properties, such as tensile strength. As used herein, the phrase “glass fiber” refers to any material that includes glass and has an aspect ratio of at least 2:1, or, in some embodiments, 10:1, 25:1, or 50:1.

The plurality of glass fibers may be dispersed in a matrix material of a laser transparent composition. In some embodiments, the plurality of glass fibers is evenly dispersed in a matrix material of a laser transparent composition.

In some embodiments, the plurality of glass fibers is present at an amount of about 1% to about 40%, by weight, based on the weight of a laser transparent composition. In some embodiments, the plurality of glass fibers is present at an amount of about 10% to about 40%, by weight, based on the weight of a laser transparent composition. In some embodiments, the plurality of glass fibers is present at an amount of about 10% to about 30%, by weight, based on the weight of a laser transparent composition. In some embodiments, the plurality of glass fibers is present at an amount of about 20%, by weight, based on the weight of a laser transparent composition.

In some embodiments, the plurality of glass fibers includes chopped strands of glass. The chopped strands of glass may be produced by chopping E-glass fibers.

In some embodiments, the plurality of glass fibers has an average filament diameter of about 10 μm to about 25 μm. In some embodiments, the plurality of glass fibers has an average filament diameter of about 10 μm to about 20 μm. In some embodiments, the plurality of glass fibers has an average filament diameter of about 13 μm to about 15 μm.

In some embodiments, the plurality of glass fibers has an average length of about 1 mm to about 10 mm. In some embodiments, the plurality of glass fibers has an average length of about 1 mm to about 8 mm. In some embodiments, the plurality of glass fibers has an average length of about 1 mm to about 6 mm. In some embodiments, the plurality of glass fibers has an average length of about 2 mm to about 6 mm. In some embodiments, the plurality of glass fibers has an average length of about 3 mm to about 5 mm.

In some embodiments, the plurality of glass fibers has an average filament diameter of about 10 μm to about 25 μm, and an average length of about 1 mm to about 10 mm. In some embodiments, the plurality of glass fibers has an average filament diameter of about 10 μm to about 25 μm, and an average length of about 1 mm to about 8 mm. In some embodiments, the plurality of glass fibers has an average filament diameter of about 10 μm to about 25 μm, and an average length of about 1 mm to about 6 mm. In some embodiments, the plurality of glass fibers has an average filament diameter of about 10 μm to about 25 μm, and an average length of about 2 mm to about 6 mm. In some embodiments, the plurality of glass fibers has an average filament diameter of about 10 μm to about 25 μm, and an average length of about 3 mm to about 5 mm.

In some embodiments, the plurality of glass fibers has an average filament diameter of about 10 μm to about 20 μm, and an average length of about 1 mm to about 10 mm. In some embodiments, the plurality of glass fibers has an average filament diameter of about 10 μm to about 20 μm, and an average length of about 1 mm to about 8 mm. In some embodiments, the plurality of glass fibers has an average filament diameter of about 10 μm to about 20 μm, and an average length of about 1 mm to about 6 mm. In some embodiments, the plurality of glass fibers has an average filament diameter of about 10 μm to about 20 μm, and an average length of about 2 mm to about 6 mm. In some embodiments, the plurality of glass fibers has an average filament diameter of about 10 μm to about 20 μm, and an average length of about 3 mm to about 5 mm.

In some embodiments, the plurality of glass fibers includes THERMOFLOW® EC14-738 glass fibers (Johns Manville, USA).

Coupling Agent

In some embodiments, the laser transparent compositions include a coupling agent, which may couple glass fibers and a matrix material. A coupling agent may include a maleic anhydride grafted polypropylene homopolymer or copolymer. The maleic anhydride may be present at an amount of about 1% by weight, based on the weight of the coupling agent. In some embodiments, a coupling agent is present in a laser transparent composition at an amount of about 0.5% to about 5% by weight, based on the weight of the laser transparent composition. In some embodiments, the coupling agent is BONDYRAM® 1001 (Polyram, Ram-On Industries, USA), which is a maleic anhydride grafted homopolymer. In some embodiments, BONDYRAM® 1001 is present in a composition at an amount of about 1% by weight, based on the weight of a composition.

UV Stabilizers

The laser transparent compositions may include a UV stabilizer. As used herein, the phrase “UV stabilizer” refers to any compound that is capable of absorbing UV radiation, and releasing the energy as heat at a level that prevents or slows degradation of a laser transparent composition.

In some embodiments, a UV stabilizer is present in the laser transparent compositions provided herein at an amount of about 0.1% to about 2%, by weight, based on the weight of the laser transparent composition. In some embodiments, a UV stabilizer is present in the laser transparent compositions provided herein at an amount of about 0.1% to about 1%, by weight, based on the weight of the laser transparent composition. In some embodiments, a UV stabilizer is present in the laser transparent compositions provided herein at an amount of about 0.4% to about 0.8%, by weight, based on the weight of the laser transparent composition. In some embodiments, a UV stabilizer is present in the laser transparent compositions provided herein at an amount of about 0.6%, by weight, based on the weight of the laser transparent composition.

Any UV stabilizer may be used in the laser transparent compositions provided herein. In some embodiments, the UV stabilizer of the laser transparent compositions includes HOSTAVIN® N 30 UV stabilizer, CHIMASSORB®-LS119 UV stabilizer, SABOSTAB® UV 62 UV stabilizer, or a combination thereof.

Additives

The laser transparent compositions provided herein may include one or more additives. Non-limiting examples of the one or more additives include auxiliary colorants, dispersants, fillers, plasticizers, modifiers, antioxidants, antistatic agents, lubricants, releasing agents, crystallization promoters, nucleating agents, fire retardants, elastomers, or a combination thereof. The one or more additives may be added according to techniques disclosed in the art.

The one or more additives may be included in the laser transparent compositions at amounts that may achieve a desired purpose of the one or more additives. In some embodiments, the one or more additives, in total, are present in the laser transparent compositions at an amount of no greater than 10%, by weight, 5%, by weight, or 1%, by weight, based on the total weight of the laser transparent composition. For example, the one or more additives may be independently present at an amount of about 0.01% to about 0.2%, about 0.1%, or about 0.2%, by weight, based on the weight of a laser transparent composition.

In some embodiments, the laser transparent compositions provided herein include an antioxidant. In some embodiments, the antioxidant includes SONGNOX® 1680, SONGNOX® 1010, or a combination thereof (SONGWON Industrial Group, USA).

In some embodiments, the laser transparent compositions provided herein include a lubricant. In some embodiments, the lubricant includes calcium stearate.

Methods

Methods of laser welding are provided. The laser welding methods provided herein may be used to join a laser transparent composition provided herein with a laser absorbing composition.

In some embodiments, the methods of laser welding include providing (i) a laser transparent composition as provided herein, and (ii) a laser absorbing composition that is black in color, wherein the laser transparent composition and the laser absorbing composition contact each other at an interface. The laser transparent composition and the laser absorbing composition may be of any shape, and the shapes of the two compositions may be the same or different. For example, one of the compositions may be in the shape of a plug, and the other composition may be in the shape of an orifice designed to receive the plug. The laser transparent composition and the laser absorbing composition may, independently, be flexible or rigid.

In some embodiments, the methods also include directing laser radiation through the laser transparent composition to heat at least a portion of the laser absorbing composition at the interface for a time effective to liquefy at least part of (i) the portion of the laser absorbing composition at the interface, (ii) a portion of the laser transparent composition at the interface, or (iii) a combination thereof. In some embodiments, the methods of laser welding also include solidifying (i) the portion of the laser absorbing composition at the interface, (ii) the portion of the laser transparent composition at the interface, or (iii) a combination thereof to weld the laser transparent composition and the laser absorbing composition together at the interface.

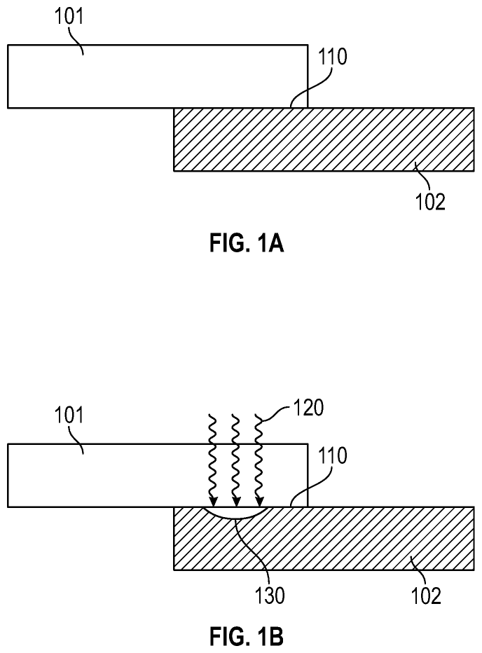

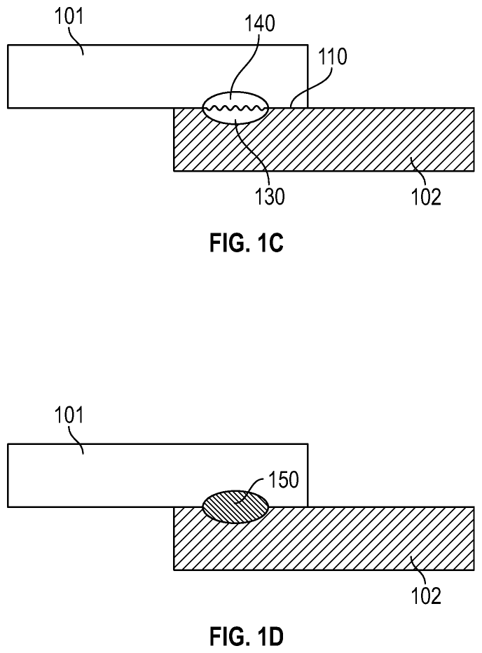

A schematic of an embodiment of a laser welding process is depicted at FIG. 1A-FIG. 1D. FIG. 1A depicts a sheet 101 formed of an embodiment of a laser transparent composition provided herein. The sheet 101 contacts a sheet 102 of a laser absorbing composition at an interface 110. Although the interface 110 of FIG. 1A results from a partial overlap of sheet 101 and sheet 102, other configurations are envisioned, such as an interface formed by a complete overlap of one sheet by another.

FIG. 1B depicts an embodiment of directing laser radiation 120 through the sheet 101 of a laser transparent composition to heat a portion of the sheet 102 of a laser absorbing composition at the interface 110. At least a portion of the laser radiation 120 is absorbed by the sheet 102 of a laser absorbing composition, and the absorbed energy is converted into heat, thereby resulting in a heated and subsequently liquefied portion 130.

As depicted at FIG. 1C, the heating or heating and liquefying of the portion 130 of the sheet 102 of a laser absorbing composition may, via conduction or otherwise, cause a portion 140 of the sheet 101 of a laser transparent composition to become heated or heated and subsequently liquefied. The heating or heating and liquefying of the portion 140 of the sheet 101 of a laser transparent composition may occur during or after the application of laser radiation 120. The liquefied portions (130, 140) may mix together at least near the interface, or a boundary may be maintained between the liquefied portions (130, 140).

The liquefied portions (130, 140) may be allowed to solidify, thereby forming a solidified region 150 that welds sheet 101 and sheet 102 together. At least a portion of the solidified region 150 may include a mixture of the laser transparent composition and the laser absorbing composition of sheet 101 and sheet 102, respectively.

Any equipment capable of generating laser radiation may be used in the methods provided herein. The laser radiation may be provided by an Nd:YAG laser or a diode laser, and these lasers may emit radiation that will achieve at least 50% transmission through a laser transparent composition. In some embodiments, the laser includes one or more wavelengths of 740 nm or greater. In some embodiments, the laser radiation is provided with a diode laser.

The intensity, density, and/or irradiating area of the laser may be selected to achieve heating and subsequent liquefying of a laser absorbing composition. For example, one or more of these parameters may be adjusted to achieve a welding having one or more characteristics, such as strength, durability, etc.

Laser Absorbing Compositions

Any laser absorbing compositions may be used in the methods provided herein. Examples of laser absorbing compositions are provided at U.S. Patent Application Publication No. 2003/0039837 and U.S. Patent Application Publication No. 2005/0203225, which are incorporated herein by reference. The color of a laser absorbing composition and a laser transparent composition may be the same or different. For example, a laser absorbing composition and a laser transparent composition may be different shades of black.

The laser absorbing compositions include one or more laser absorbing materials. In some embodiments, the laser absorbing material is carbon black, which may serve as a colorant. Other examples of laser absorbing materials include, but are not limited to, azine compounds, phthialocyanine compounds, polymethine compounds (cyanine compounds, pyrylium compounds, thiopyrylium compounds, squalilium compounds, croconium compounds, azulenium compounds), diinmonium compounds, dithiol metal complex salt compounds (M=Ni, Fe, etc.), indoaniline metal complex compounds, and mercaptonaphthol metal complex salt compounds.

The amount of laser absorbing material used in a laser absorbing composition should be sufficient to achieve a desired heating with laser radiation. In some embodiments, a laser absorbing composition, such as carbon black, is present in a laser absorbing composition at an amount of about 0.01% to about 20%, by weight, based on the weight of the laser absorbing composition. In some embodiments, a laser absorbing composition, such as carbon black, is present in a laser absorbing composition at an amount of about 0.01% to about 15%, by weight, based on the weight of the laser absorbing composition. In some embodiments, a laser absorbing composition, such as carbon black, is present in a laser absorbing composition at an amount of about 0.01% to about 10%, by weight, based on the weight of the laser absorbing composition. In some embodiments, a laser absorbing composition, such as carbon black, is present in a laser absorbing composition at an amount of about 0.01% to about 5%, by weight, based on the weight of the laser absorbing composition.

In the descriptions provided herein, the terms “includes,” “is,” “containing,” “having,” and “comprises” are used in an open-ended fashion, and thus should be interpreted to mean “including, but not limited to.” When methods or compositions are claimed or described in terms of “comprising” or “including” various elements or features, the methods can also “consist essentially of” or “consist of” the various components or features, unless stated otherwise.

The terms “a,” “an,” and “the” are intended to include plural alternatives, e.g., at least one. For instance, the disclosure of “a compatibilizer,” “a UV stabilizer,” “a matrix material”, and the like, is meant to encompass one, or mixtures or combinations of more than one compatibilizer, UV stabilizer, matrix material, and the like, unless otherwise specified.

Various numerical ranges may be disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Moreover, numerical end points of ranges disclosed herein are approximate. As a representative example, Applicant discloses that, in some embodiments, a UV stabilizer is present at an amount of about 0.1% to about 2%, by weight, based on the weight of the laser transparent composition. This disclosure should be interpreted as encompassing values of about 0.1% to about 2%, by weight, and further encompasses “about” each of 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, and 1.9%, including any ranges and sub-ranges between any of these values.

The present embodiments are illustrated herein by referring to various embodiments, which are not to be construed in any way as imposing limitations upon the scope thereof. On the contrary, it is to be understood that resort may be had to various other aspects, embodiments, modifications, and equivalents thereof which, after reading the description herein, may suggest themselves to one of ordinary skill in the art without departing from the spirit of the present embodiments or the scope of the appended claims. Thus, other aspects of the embodiments will be apparent to those skilled in the art from consideration of the specification and practice of the embodiments disclosed herein.

The present disclosure is further illustrated by the following examples, which are not to be construed in any way as imposing limitations upon the scope thereof. On the contrary, it is to be understood that resort may be had to various other aspects, embodiments, modifications, and equivalents thereof which, after reading the description herein, may suggest themselves to one of ordinary skill in the art without departing from the spirit of the present disclosure or the scope of the appended claims. Thus, other aspects of this disclosure will be apparent to those skilled in the art from consideration of the specification and practice of the disclosure disclosed herein.

### EXAMPLES

### Example 1—Laser Transparency

A laser transparent composition was prepared that included the components of the following table:

| Component | Description | Amount |
|---|---|---|
| Matrix | EXXONMOBIL ® | 76.2%, by weight, based on |
| Material | ACHIEVE ® Advanced | the weight of the laser |
| | PP1605 polypropylene | transparent composition |
| Dye System | MACROLEX ® Red EG | 0.2% (0.1% each), by weight, |
| | dye, and MACROLEX ® | based on the weight of the |
| | Green 5B (50:50 weight | laser transparent composition |
| | ratio) | |
| Compatibilizer | Acrylic Acid Modified | 3%, by weight, based on the |
| | Polypropylene Polymer | weight of the laser transparent |
| | | composition |
| Plurality of | THERMOFLOW ® | 20%, by weight, based on the |
| Glass Fibers | EC14-738 glass fibers | weight of the laser transparent |
| | | composition |
| Coupling | BONDYRAM ® 1001 | 1%, by weight, based on the |
| Agent | coupling agent | weight of the laser transparent |
| | | composition |
| UV Stabilizer | HOSTAVIN ® N 30 UV | 0.6%, by weight, based on the |
| | stabilizer | weight of the laser transparent |
| | | composition |
| Additive(s) | SONGNOX ® 1680 | 0.1% each, by weight, based |
| | Anti-oxidant | on the weight of the laser |
| | SONGNOX ® 1010 | transparent composition |
| | Anti-oxidant | |
| Lubricant | Calcium Stearate | 0.2%, by weight, based on the |
| | | weight of the laser transparent |
| | | composition |

The laser transparent composition of this example was 3 mm thick, and had a laser transparency of 100% at wavelengths of about 740 nm and greater. Therefore, the laser transparent compound of this example can be laser welded to another laser absorbing material nearly independent of machine type.

### Example 2—Weathering Study

Four laser transparent compositions were made in this example, and subjected to a weathering study (SAE J2527™ standard test, “Performance Based Standard for Accelerated Exposure of Automotive Exterior Materials Using a Controlled Irradiance Xenon-Arc Apparatus”).

The SAE J2527™ standard test relied on a program cycle that provided 120 minutes of light and 60 minutes of dark in the following cycle: 60 minutes of dark with both back and front-spray, 40 minutes of light followed by 20 minutes of light and front specimen spray, followed by 60 minutes of light, and repeating. The test sequenced followed the conditions of the following table:

| Step | Light | Dark | Spray |
|---|---|---|---|
| 1 | None | 60 min. | Front and back |
| 2 | 40 min./1.32 kJ · m⁻² · nm⁻¹ | N/A | None |
| 3 | 20 min./0.66 kJ · m⁻² · nm⁻¹ | N/A | Front |
| 4 | 60 min./1.98 kJ · m⁻² · nm⁻¹ | N/A | None |

In the foregoing table, the radiant dosages were based on an irradiance level of 0.55 Wm⁻²nm⁻¹ at 340 nm. The target values at the control panel sensor for the SAE J2527™ standard test are provided at the following table:

| | Dark + Spray Step 1 | | Light, Steps 2, 3, 4, | |
|---|---|---|---|---|
| | | Operational | | Operational |
| Controls | Target | Fluctuation | Target | Fluctuation |
| Automatic | None | | 0.55 Wm⁻²nm⁻¹ | |
| Irradiance | | | at 340 nm | |
| Black Panel | None | | 70° C. | ±3° C. |
| Temp. | | | | |
| Chamber Air | 38° C. | N/A | 47° C. | ±3° C. |
| Temp. | | | | |
| (Dry bulb) | | | | |
| Relative | 95% | N/A | 50% | ±10° C. |
| Humidity | | | | |
| Radiant | None | | See application | |
| Exposure | | | specification | |

The four transparent compositions tested in this example were identical to those compositions of the previous example, except as indicated in the following table:

| Sample | Component | Description | Amount |
|---|---|---|---|
| 1 | Compatibilizer | Acrylic Acid | 3%, by weight, based |
| | | Modified | on the weight of the |
| | | Polypropylene | laser transparent |
| | | Polymer | composition |
| | UV Stabilizer | CHIMASSORB ®- | 0.6%, by weight, |
| | | LS119 UV | based on the weight of |
| | | stabilizer | the laser transparent |
| | | SABOSTAB ® | composition (0.4%, |
| | | 62 UV stabilizer | by weight, |
| | | | CHIMASSORB ® |
| | | | LS119; 0.2%, by |
| | | | weight, |
| | | | SABOSTAB ® 62) |
| 2 | Compatibilizer | Acrylic Acid | 3%, by weight, based |
| | | Modified | on the weight of the |
| | | Polypropylene | laser transparent |
| | | Polymer | composition |
| | UV Stabilizer | HOSTAVIN ® N | 0.6%, by weight, |
| | | 30 UV stabilizer | based on the weight of |
| | | | the laser transparent |
| | | | composition |
| 3 | Compatibilizer | Acrylic Acid | 1%, by weight, based |
| | | Modified | on the weight of the |
| | | Polypropylene | laser transparent |
| | | Polymer | composition |
| | UV Stabilizer | CHIMASSORB ®- | 0.6%, by weight, |
| | | LS119 UV | based on the weight of |
| | | stabilizer | the laser transparent |
| | | SABOSTAB ® | composition (0.4%, |
| | | 62 UV stabilizer | by weight, |
| | | | CHIMASSORB ® |
| | | | LS119; 0.2%, by |
| | | | weight, |
| | | | SABOSTAB ® 62) |
| 4 | Compatibilizer | Acrylic Acid | 1%, by weight, based |
| | | Modified | on the weight of the |
| | | Polypropylene | laser transparent |
| | | Polymer | composition |
| | UV Stabilizer | HOSTAVIN ® N | 0.6%, by weight, |
| | | 30 UV stabilizer | based on the weight of |
| | | | the laser transparent |
| | | | composition |

The weathering test of this example indicated that the dE (i.e., color change) for each of Samples 2-4 was less than 4.0 at 2,000 KJ/m². For Sample 2, the dE was less than 4.00 at 2,500 KJ/m². The dE was based on a measurement of the change in the color variables “L” (lightness), “a” (red/green), and “b” (blue/yellow).

The compositions of the foregoing examples are provided to demonstrate certain features, and do not limit the scope of the following claims.

1. A laser transparent composition having a black color, the laser transparent composition comprising:
a matrix material comprising a polypropylene;
a dye system, wherein the dye system is (i) dispersed in the matrix material, and (ii) present at an amount of about 0.05% to about 0.5%, by weight, based on the weight of the laser transparent composition;
a compatibilizer, wherein the compatibilizer is (i) dispersed in the matrix material, and (ii) present at an amount of about 0.1% to about 10%, by weight, based on the weight of the laser transparent composition;
a plurality of glass fibers, wherein the plurality of glass fibers is (i) dispersed in the matrix material, and (ii) present at an amount of about 1% to about 40%, by weight, based on the weight of the laser transparent composition; and
a UV stabilizer, wherein the UV stabilizer is (i) dispersed in the matrix material, and (ii) present at an amount of about 0.1% to about 2%, by weight, based on the weight of the laser transparent composition;
wherein the laser transparent composition has a laser transparency of at least 50%.

2. The laser transparent composition of claim 1, wherein the laser transparent composition has a laser transparency of at least 65%.

3. The laser transparent composition of claim 1, wherein the dye system comprises two or more polar organic compounds.

4. The laser transparent composition of claim 3, wherein the two or more polar organic compounds of the dye system comprise a red dye and a green dye, and wherein the red dye and the green dye are present in the dye system at a weight ratio of about 40:60 (red dye:green dye) to about 60:40 (red dye:green dye).

5. The laser transparent composition of claim 4, wherein (i) the red dye comprises MACROLEX® Red EG dye, (ii) the green dye comprises MACROLEX® Green 5B, or (iii) the red dye comprises MACROLEX® Red EG dye and the green dye comprises MACROLEX® Green 5B.

6. The laser transparent composition of claim 1, wherein the compatibilizer comprises a modified polypropylene homopolymer, wherein the modified polypropylene homopolymer comprises
(i) a polypropylene homopolymer, and
(ii) a monomer comprising a polar functional group;
wherein the monomer comprising the polar functional group is (a) grafted to the polypropylene homopolymer, and (b) present at an amount of about 3 mole % to about 10 mole % relative to the moles of polypropylene monomer in the polypropylene homopolymer.

7. The laser transparent composition of claim 6, wherein the compatibilizer has (i) a density of about 0.8 g/cm³ to about 1 g/cm³, (ii) a melt flow rate of about 30 g/10 minutes to about 50 g/10 minutes, or (iii) a combination thereof.

8. The laser transparent composition of claim 6, wherein the compatibilizer has (i) a density of about 0.91 g/cm³, (ii) a melt flow rate of about 42 g/10 minutes, or (iii) a combination thereof.

9. The laser transparent composition of claim 6, wherein the polar functional group comprises a carboxylic acid.

10. The laser transparent composition of claim 9, wherein the monomer comprising the polar functional group comprises acrylic acid, maleic anhydride, or a combination thereof.

11. The laser transparent composition of claim 1, wherein the plurality of glass fibers has an average filament diameter of about 10 p.m to about 25 p.m, and an average length of about 1 mm to about 10 mm.

12. The laser transparent composition of claim 1, wherein the plurality of glass fibers is present at an amount of about 10% to about 30%, by weight, based on the weight of the laser transparent composition.

13. The laser transparent composition of claim 1, wherein the plurality of glass fibers comprises THERMOFLOW® EC14-738 glass fibers.

14. The laser transparent composition of claim 1, wherein the UV stabilizer is present at an amount of about 0.5% to about 0.7%, by weight, based on the weight of the laser transparent composition.

15. The laser transparent composition of claim 1, wherein the UV stabilizer comprises HOSTAVIN® N 30 UV stabilizer, CHIMASSORB®-LS119 UV stabilizer, SABOSTAB® UV 62 UV stabilizer, or a combination thereof.

16. The laser transparent composition of claim 1, wherein the laser transparent composition is UV stable up to at least 2000 KJ/m².

17. The laser transparent composition of claim 1, wherein the polypropylene of the matrix material comprises EXXONMOBIL® PP1105E1 polypropylene, EXXONMOBIL® ACHIEVE® Advanced PP1605 polypropylene, or a combination thereof.

18. A method of laser welding, the method comprising:
providing (i) the laser transparent composition of claim 1, and (ii) a laser absorbing composition that is black in color, wherein the laser transparent composition and the laser absorbing composition contact each other at an interface; and
directing laser irradiation through the laser transparent composition to heat at least a portion of the laser absorbing composition at the interface for a time effective to liquefy at least part of (i) the portion of the laser absorbing composition at the interface, (ii) a portion of the laser transparent composition at the interface, or (iii) a combination thereof.

19. The method of claim 18, further comprising solidifying (i) the portion of the laser absorbing composition at the interface, (ii) the portion of the laser transparent composition at the interface, or (iii) a combination thereof to weld the laser transparent composition and the laser absorbing composition together at the interface.

20. The method of claim 18, wherein the laser absorbing composition comprises carbon black.
